(19) United States
(12) Patent Application Publication
(10) Pub. No.: US 2026/0036480 A1
(43) Pub. Date: Feb. 5, 2026

(54) TRANSDUCER SYSTEM

(71) Applicant: Forcen Inc., Toronto (CA)

(72) Inventors: Bavly Fahmy, Mississauga (CA); Samuel Kim, Toronto (CA); I-Hsiang Chen, Toronto (CA); Robert Joseph Brooks, Mississauga (CA)

(21) Appl. No.: 19/300,215

(22) Filed: Aug. 14, 2025

Related U.S. Application Data
(63) Continuation of application No. PCT/CA2024/050193, filed on Feb. 15, 2024.
(60) Provisional application No. 63/445,795, filed on Feb. 15, 2023.

(51) Int. Cl. G01L 5/22; G01M 1/12

(52) U.S. Cl. CPC G01L 5/226; G01M 1/122

(57) ABSTRACT

A transducer system having a transducer structure with a plurality of surfaces to be measured and at least one coupling member for removably coupling an object to the transducer structure. The transducer being coupled to the transducer structure and having at least one strain sensor coupled to the plurality of surfaces to be measured for measuring deformation of the transducer structure in a plurality of directions. The system has a dynamic measurement unit for measuring at least one acceleration of the object and at least one controller. The controller is configured to receive the deformation measurements in the plurality of directions; receive the acceleration measurements; and when the object is removably coupled to the coupling member, determine at least one of mass, moment of inertia, and centre of gravity of the object based on the deformation and acceleration measurements.

### CROSS-REFERENCE TO RELATED APPLICATIONS

This application is a continuation of PCT/CA2024/050193 filed Feb. 15, 2024 which claims priority from U.S. Provisional Patent Application No. 63/445,795, filed Feb. 15, 2023, the entire contents of which are hereby incorporated by reference in their entirety.

### FIELD OF THE INVENTION

The present invention is directed to the field of transducers. More particularly, the present invention provides a transducer structure for receiving a transducer to form a transducer system.

### Introduction

Automated systems may be used for controlling the motion of objects in different scenarios. For example, a robotic arm may be used for part-picking in a factory. To prevent the robotic arm from being damaged by attempting to pick up a heavy object too quickly, optical systems may be used to tell the system how much the object weighs. An example optical system is one that uses a camera to scan a barcode on the object. However, if the object is turned over or the barcode has been damaged, the system may have difficulty determining which object is being moved and how much it weighs.

Lack of, or improper determination of the weight of the object can lead to damage to the robotic arm, damage to the object, and/or dropping of the object onto the ground of the, e.g., factory. Dropping the object can cause significant delays to the operation of the factory or other system.

### SUMMARY OF THE INVENTION

In accordance with one aspect of this disclosure, there is provided a transducer system, the transducer system comprising:
a transducer structure having a plurality of surfaces to be measured and at least one coupling member for removably coupling an object to the transducer structure;
a transducer coupled to the transducer structure, the transducer having at least one strain sensor coupled to the plurality of surfaces to be measured for measuring deformation of the transducer structure in a plurality of directions;
a dynamic measurement unit for measuring at least one acceleration of the object; and
at least one controller configured to:
   receive the deformation measurements in the plurality of directions;
   receive the acceleration measurements; and
   when the object is removably coupled to the coupling member, determine at least one of mass, moment of inertia, and centre of gravity of the object based on the deformation and acceleration measurements.

In any embodiment, the dynamic measuring unit may be at least one of a gyroscope, an accelerometer, and an inertial measurement unit.

In any embodiment, the at least one strain sensor may be a plurality of strain sensors.

In any embodiment, the plurality of strain sensors may include at least three strain sensors and the plurality of directions may include a first direction, a second direction, and a third direction, wherein each of the first direction, the second direction, and the third direction may be perpendicular from one another, wherein the at least one controller may be further configured to:
when the object is coupled to the coupling member, determine a force acting in the third direction based on deformation measurements from the three strain sensors in the first direction and the second direction and measure at least one angular value of the object using the dynamic measuring unit;
determine an angular offset between the angular value of the object and a direction of gravity; and
determine the at least one of mass, moment of inertia, and centre of gravity of the object based on the force and angular offset.

In any embodiment, the plurality of strain sensors may include at least four strain sensors,
wherein when the object is coupled to the coupling member, at least one strain sensor of the plurality of strain sensors may be configured to measure deformation of the transducer system as a result of torque, and
wherein the controller is further configured to:
   determine the at least one of mass, moment of inertia, and centre of gravity of the object based on the force, torque, and angular offset.

In any embodiment, the plurality of strain sensors may include at least two strain sensors,
wherein when the object is coupled to the coupling member, at least one strain sensor of the plurality of strain sensors may be configured to measure deformation of the transducer system as a result of torque and at least one strain sensor of the plurality of strain sensors may be configured to measure deformation of the transducer system as a result of force, and
wherein the controller may be further configured to:
determine the at least one of mass, moment of inertia, and centre of gravity of the object based on the force and torque.

In any embodiment, the transducer structure, the dynamic measuring unit, and the coupling member may be mechanically linked.

In any embodiment, the at least one controller may be further configured to time synchronize the deformation measurements and the acceleration measurements.

In any embodiment, the transducer system may further comprise at least one actuator for actuating the at least one coupling member to control a movement of the object when the object is coupled to the coupling member.

In any embodiment, the controller may be operable to control the movement of the object in at least one of an angular plane and a cartesian plane using the actuator.

In any embodiment, movement of the object may include at least one of linear velocity, linear acceleration, angular velocity, and angular acceleration.

In any embodiment, the at least one controller may be further configured to control the movement of the object with the at least one actuator based on at least one of the determined mass, moment of inertia, and centre of gravity.

In any embodiment, the at least one controller may be further configured to:
determine at least one of a structural compliance of the object and a coupling force between the object and the at least one coupling member;
determine a threshold velocity and a threshold acceleration based on at least one of the structural compliance and the coupling force; and
actuate the object with the actuator to move the object below the threshold velocity and the threshold acceleration.

In any embodiment, the at least one controller may be further configured to update the threshold velocity and the threshold acceleration over time and to control the movement of the object with the actuator based on the updated threshold velocity and the threshold acceleration.

In any embodiment, the at least one controller may be further configured to:
access a memory, the memory containing an acceleration shift parameter,
predict a change in the center of gravity of the object based on the acceleration shift parameter; and
modify the movement of the object using the at least one actuator based on the acceleration shift parameter such that the object moves below the threshold velocity and the threshold acceleration.

In any embodiment, the acceleration shift parameter may be determined by operating the at least one actuator to move the object through an initial sequence.

In any embodiment, the at least one actuator may be operated to move the object through one or more secondary sequences and the acceleration shift parameter may be updated over time.

In any embodiment, the acceleration shift parameter may be programmed into the memory prior to operation of the transducer system.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a side view of a transducer system in accordance with an embodiment herein;

FIG. 2 is a side perspective view of the transducer system of FIG. 1 with an object coupled to a coupling member;

FIG. 3 is a side perspective view of the transducer system of FIG. 1;

FIG. 4 is a control system diagram in accordance with another embodiment herein;

FIG. 5 is a top view of a transducer structure in accordance with another embodiment herein;

FIG. 6 is a bottom view of the transducer structure of FIG. 5;

FIG. 7 is a top perspective view of the transducer structure of FIG. 5;

FIG. 8 is a bottom perspective view of the transducer structure of FIG. 5;

FIG. 9 is an exploded view of the transducer structure of FIG. 5;

FIG. 10 is a cross-sectional side view of the transducer structure of FIG. 5, taken along the line A-A in FIG. 5;

FIG. 11 is a side view of the transducer structure of FIG. 5;

FIG. 12 is a top perspective view of a transducer structure in accordance with another embodiment herein;

FIG. 13 is a top view of the transducer structure of FIG. 12;

FIG. 14 is a bottom perspective view of the transducer structure of FIG. 12;

FIG. 15 is an exploded view of the transducer structure of FIG. 12;

FIG. 16 is a top view of another transducer structure in accordance with another embodiment herein;

FIG. 17 is a bottom perspective view of the transducer structure of FIG. 16;

FIG. 18 is an exploded view of the transducer structure of FIG. 16; and

FIG. 19 is a flowchart of an example method of processing data flow in a transducer system.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

As used herein and in the claims, two elements are said to be “parallel” where those elements are parallel and spaced apart, or where those elements are collinear.

### Introduction

Automated systems for moving objects may face difficulties when trying to use a single system for moving objects of different sizes, shapes, weights, material, compliance, and/or other variable characteristics. Optical systems can be used to scan a barcode on the object to determine, for example, the weight of the object based on data stored in a database, so that the system can calculate the limits associated with the movement of that object, such as velocity and acceleration thresholds. However, if the object is rotated and the barcode is not visible, the system cannot determine the nature of the object. This lack of understanding can lead to dropped, crushed, or otherwise damaged objects, which may in turn damage or impede other operations. The lack of understanding may also damage to the system itself. For example, if the system includes a robotic arm, the robotic arm may attempt to accelerate a heavier-than-expected object too rapidly, thereby damaging the robot or decreasing the lifespan of its components due to repeated overloading.

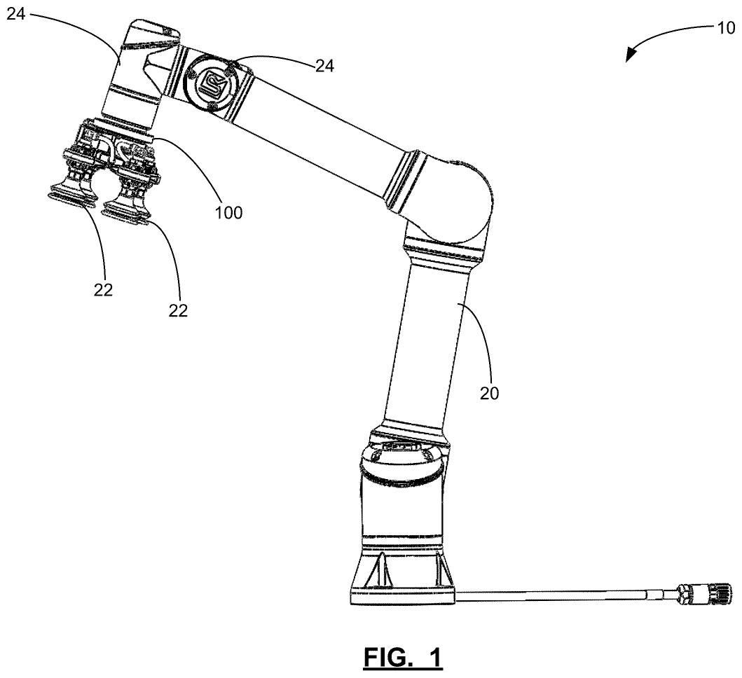

Referring to FIG. 1, shown therein is an example system 10 for controlling the movement of objects. The system 10 may be referred to as a transducer system 10, having a transducer structure 100, a transducer 300, and a dynamic measuring unit 400.

As exemplified in FIG. 1, the transducer structure 100 is coupled to an actuatable member 20. The actuatable member 20 may be any device capable of moving an object 40 as part of the system 10. For example, as shown in FIG. 1, the actuatable member 20 may be a robotic arm. The transducer structure 100 may be connected to a coupling member 22, the coupling member 22 for removably coupling the object 40 to the transducer structure 100. The coupling member 22 may be any mechanism capable of coupling with an object. For example, the coupling member 22 may be, including, but not limited to, one or more suction devices, fingers, grips, pincers, hands, or any combination thereof. Accordingly, the transducer system 10 may be used to pick up and/or otherwise control the movement of the object 40 using the coupling member 22. The transducer structure 100 may be positioned anywhere in the system 10 such that the transducer 300 is able to measure deformation of the transducer structure 100 as a result of using the system 10.

When the object 40 is coupled to the coupling member 22, the transducer 300 may be used to measure the deformation of the transducer structure 100. The dynamic measuring unit 400 may be used to measure one or more parameters of the movement of the transducer structure 100 and/or the object 40, including, but not limited to, acceleration and/or angular values of the object 40 in 3D space. Based on these measurements, at least one of mass, moment of inertia, and/or centre of gravity of the object 40 may be determined. Movement of the object 40 may include, but is not limited to, one or more of linear velocity, linear acceleration, angular velocity, and/or angular acceleration.

By knowing one or more of these parameters related to the object 40, the system 10 may be used to more safely and efficiently move the object 40 while reducing the likelihood of dropping, crushing, or otherwise damaging the object 40 and/or the system 10.

### Transducer and Transducer Structure

Referring to FIG. 1, shown therein is an example embodiment of a transducer structure 100 with a transducer 300. The transducer 300 is positioned on the transducer structure 100 such that the transducer 300 can measure one or more types of data based on changes to the transducer structure 100. For example, the transducer 300 may include, but is not limited to, force sensors, strain gauges, piezoelectric sensors, capacitive force sensors, optical force sensors, fiber optic force sensors, Bragg's diffraction gratings, silicone strain gauges, metal foil strain gauges, and/or combinations thereof.

The transducer 300 may have one or more strain gauges 310. Each strain gauge 310 may be positioned on a surface to be measured 110. There may be a single strain gauge 310 across a plurality of surfaces and/or a plurality of strain gauges 310 across a plurality of surfaces. During use, when the transducer structure 100 experiences an applied force, deformation of the transducer structure 100 results in deformation of one or more of the surfaces to be measured 110, introducing strain to the surface to be measured 110. Strain is the ratio of measured length to the original length in a particular direction. The strain gauges 310 operate to measure the relative change to the surface to be measured 110, such that the deformation can be calculated. For example, if the surface to be measured 110 is compressed, the strain value will be less than 1. Conversely, if the surface to be measured 110 is elongated, the strain value will be greater than 1.

Measuring the strain of a surface to be measured 110 caused by the application of force to the transducer structure 100 allows for the calculation of the value of the applied force that caused the deformation of the surface to be measured 110. This calculation may be determined by using known material properties of the transducer structure 100 and the known geometry of the transducer structure 100. Thus, by measuring strain using a strain gauge, the applied force can be determined.

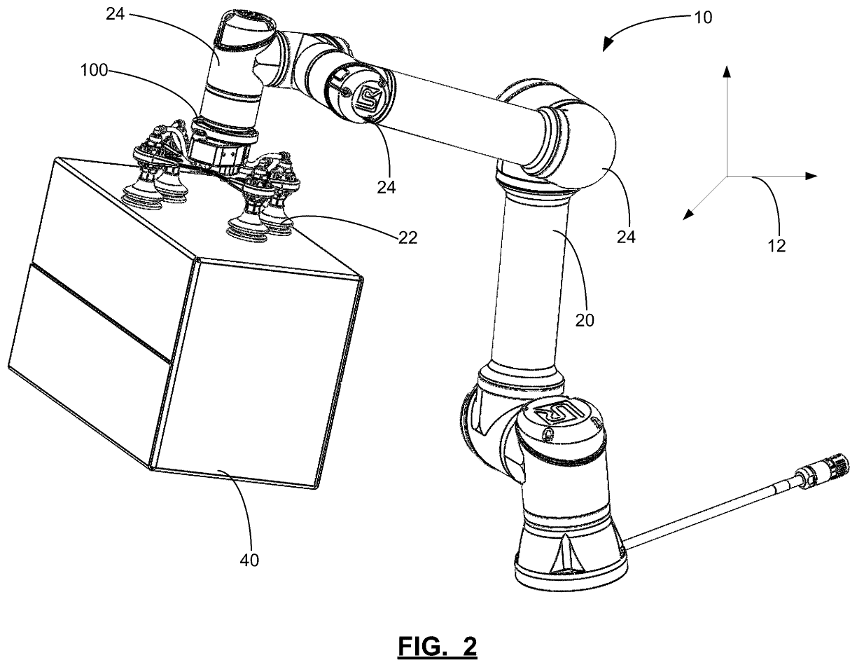

Strain is most easily measured along an axis, or, in other words, within a particular degree of freedom (DoF). For example, strain can be measured in a first direction, a second direction, and a third direction, with each of the first, second, and third directions being perpendicular to one another in a Cartesian coordinate system. These directions are typically referred to as x, y, and z directions. An example coordinate system 12 is shown in FIG. 2. Each of the three directions has a translational component, movement along the direction, and a rotational component, rotating about the axis of the direction. The translational and rotational components result in six DoF in a Cartesian coordinate system. Accordingly, an applied force can have six components: Fx, Fy, Fz, Mx, My, and Mz, where F=force and M=moment.

The applied force may not be unidirectionally applied to the transducer structure 100. For example, the force may be applied at an angle to the first, second, and/or third directions of the structure 100, thereby applying a resultant force that can be separated into axial forces applied along each direction and rotational forces causing a moment about each axis. Accordingly, to measure the applied force, the force along each axis can be calculated from measured strain values from each surface to be measured 110. In other words, the transducer 300 may be used for measuring the deformation of the transducer structure 100 in a plurality of directions.

The transducer 300 may be a thin film transducer. As exemplified, the transducer 300 can range from about 25 to about 150 microns in thickness. It will be appreciated that the transducer 300 may have a thickness in the range of about 500 nanometer to about 500 microns.

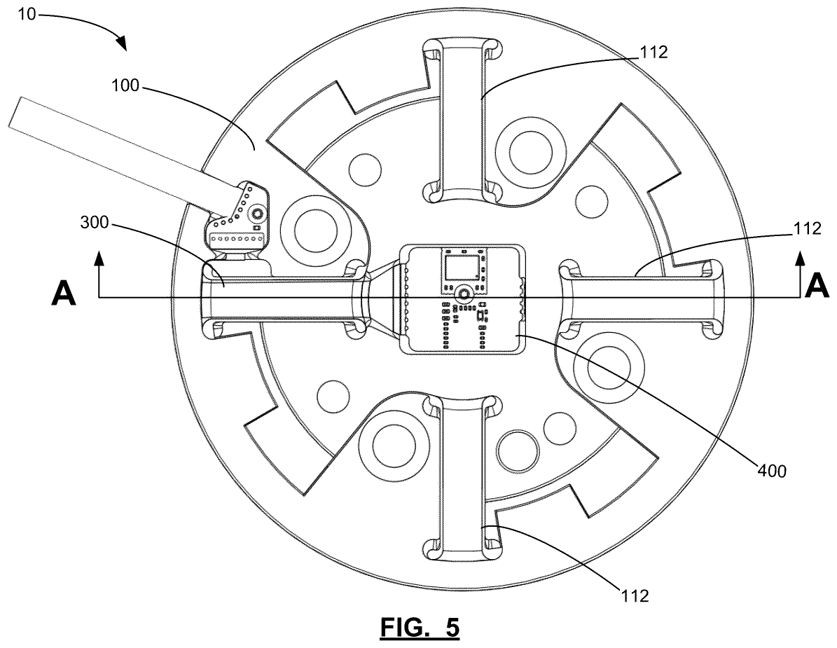

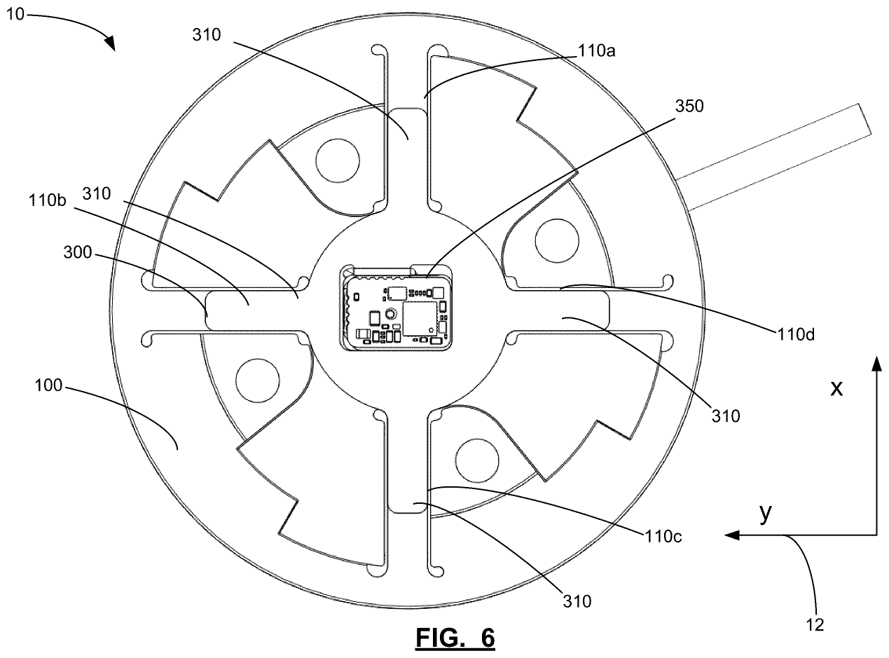

The surface to be measured 110 may be an elongate member shaped to receive the transducer 300. For example, the surface to be measured 110 may be a thin beam. To measure force and/or torque, the transducer may be secured to an elongated beam 112 to measure its relative deflection as a result of the net force/torque on the transducer structure 100. For example, the transducer 300 may have a plurality of strain gauge 310 sensors and a plurality of elongate beams 112, with each one or more sensors positioned on its respective elongate beam 112, as exemplified in FIGS. 5 and 6.

The transducer 300 may include additional sensor types, as noted above. For example, the transducer 300 may include one or more temperature sensors. The inclusion of a temperature sensor may allow for local compensation of individual transducers. In other words, the temperature sensor may be used in combination with the deformation sensors to account for temperature changes and gradients, thereby improving the accuracy of the output data from the transducer 300.

### Dynamic Measuring Unit

The transducer system 10 may include one or more dynamic measuring units 400. The dynamic measuring unit 400 may be any device capable of measuring parameters of an object 40 in motion. For example, the dynamic measuring unit 400 may be one or more of, including, but not limited to, an inertial measuring unit (IMU), accelerometer, and/or gyroscope. The dynamic measuring unit 400 may be used to measure acceleration (linear and/or angular) and/or angular values in a 3D space. For example, the angular position of an object 40 may have a varying attitude that can be measured by the dynamic measuring unit 400. Knowing the relative angular position of the object 40 compared to gravity may assist in calculating any applied force acting on transducer structure 100 as a result of the object 40, thereby reducing the likelihood of damaging the object 40 or the system 10 by excessive movement. The angular value may be one or more vectors associated with a change in roll, pitch, and/or yaw of the object 40 in 3D space.

Referring to FIG. 5, as exemplified, the system 10 includes a dynamic measuring unit 400 that is an IMU. An IMU may include a combination of one or more of accelerometers, gyroscopes, and magnetometers. The IMU may be used to measure force, angular rate, and orientation of the object 40 in 3D space. In some cases, an IMU may include a GPS receiver to provide geographical positioning. It will be appreciated that any IMU may be used. An example of an IMU used in the system 10 may be the Bosch BNO 085.

In some embodiments, the dynamic measuring unit 400 may include additional components of an electronics module. For example, the dynamic measuring unit 400 may include the controller 500 and/or one or more additional sensors. For example, the dynamic measuring unit 400 may include one or more temperature sensors and/or optical sensors.

### Application of Force

The system 10 may be used measure an applied force acting on the transducer structure 100. The applied force may come from any application, such as a transducer structure 100 coupled to an end effector for interacting with one or more objects 40 that introduce deformation to the transducer structure 100. As shown, the end effector may be the coupling member 22. For example, the transducer structure 100 shown in FIG. 1 is connectable to a coupling member 22 that may be used to interact with objects 40. The transducer 300 may be used to measure the applied force resulting from the weight of the coupling member 22 and/or resulting from an interaction between the coupling member 22 and the object 40. For example, if the coupling member 22 is used to pick up a package, the transducer system 10 may be used to calculate the applied force acting on transducer structure as a result of the connection and movement of the package.

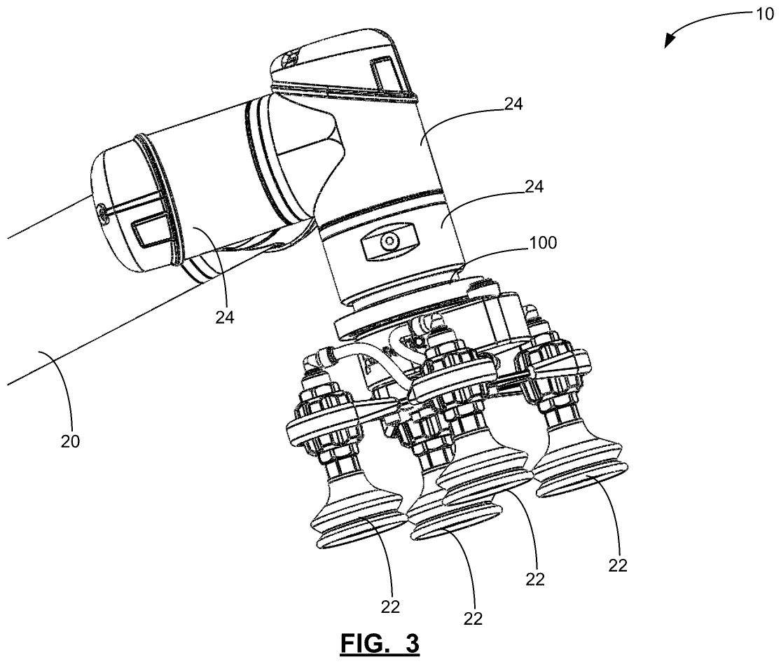

Referring to FIGS. 1-3, as exemplified, the transducer structure 100 may be positioned between a coupling member 22 and one or more actuators 24. The actuator 24 may be used to modify the position and operation of the coupling member 22 to enable the coupling member 22 to interact with one or more objects 40. The object 40 may be anything that is receivable by the coupling member 22. For example, the object 40 may be a package, item of food, manufacturing part, lumber, building materials, or any object capable of being picked up. As exemplified, the transducer structure 100, the dynamic measuring unit 400, and the coupling member 22 may be mechanically linked. A mechanical linkage between these elements may improve the response and accuracy of the deformation, acceleration and/or angular value measurements of the transducer 300 and the dynamic measuring unit 400. Accordingly, the actuator 24 may be used to control the movement of the object 40 coupled to the coupling member 22 in a way that allows the transducer 300 to measure deformations of the transducer structure as a result of the object 40 movement and that allows the dynamic measuring unit 400 to measure the acceleration and/or angular values of the object 40.

### Controller and Data Aggregation

The system 10 may include a controller 500. The controller 500 may be any device capable of computing or facilitating computation based on one or more of the deformation, acceleration, and/or angular value measurements from the transducer 300 and/or the dynamic measuring unit 400. For example, the controller 500 may be the STM32 by STmicroelectronics.

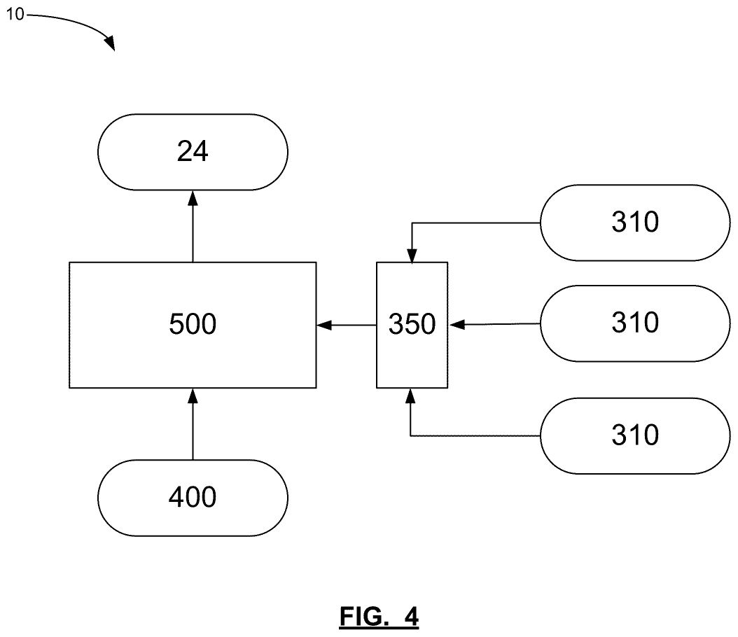

A schematic illustrating data flow with the controller 500 is exemplified in FIG. 4. The controller 500 may be analogue, digital, or a combination thereof. The controller 500 may be configured to aggregate data for external calculations or may perform the calculation itself. For example, the controller 500 may be in communication with a data acquisition unit 350 capable of receiving data from the transducer 300 and/or the dynamic measuring unit 400. The data acquisition unit 350 may also be referred to as a sensing module. The data acquisition unit 350 may include a digital to analogue converter. An example data acquisition unit may be the STM32 by STmicroelectronics. The data acquisition unit 350 may be used to condition the data from the transducer 300, optionally calibrating and/or normalizing the data.

The controller 500 may be configured to receive the deformation measurements in the plurality of directions from the transducer 300 and/or the data acquisition unit 350 and receive the acceleration and/or angular value measurements from the dynamic measuring unit 400. These measurements may be a result of deformations caused by coupling the object 40 to the coupling member 22. Accordingly, when the object 40 is removably coupled to the coupling member 22, the controller 500 may determine the mass, moment of inertia, and/or centre of gravity of the object 40 based on the received deformation and acceleration measurements.

In some embodiments, the controller 500 may be operable to time sync one or more streams of data. For example, the controller 500 may operate to synchronize the deformation, acceleration, and/or angular value data. Synchronizing the data may improve the response of the system 10 to optimize the movement of the object 40 when coupled to the coupling member 22. An advantage of this design is that the syncing of different measurements may allow the system 10 to compensate for more rapid movement of the object 40. For example, if there is a time delay between the measurement data of the transducer 300 and the dynamic measuring unit 400, temporal errors may be introduced in the calculations. By the time the controller 500 attempts to compensate for the changed value of either of the transducer 300 and the dynamic measuring unit 400, the object 40 may be in a different position and may be experiencing different accelerations and/or forces. One solution to this temporal delay error would be to move the object 40 at much slower velocity and/or accelerations such that the impact of the delay is less significant to the calculated output. In other words, slower velocity and/or acceleration may be used to manually synchronize the data. However, this solution may result in an increase in cost and decrease in efficiency of the system. In the system 10, time synchronizing of the measured data may enable the system 10 to operate at higher velocities and/or acceleration, while reducing error in the output calculations.

The controller 500 may make use of known orientation information (e.g., yaw, pitch, roll) and/or spatial values to improve the operation of the system 10. The components of the system 10 may be mechanically coupled in such a way that the relative location of each component is a fixed and known value. For example, the transducer structure 100 may be a monolithic structure. A single monolithic structure may reduce relative motion between the components of the system 10 and may reduce error. When there are more components to the system, there may be an increased likelihood of losses and irregularity that may introduce error. For example, the boundaries between components, such as screws, metal rubbing against metal, and/or overall wear may introduce slip and/or fatigue that can impact strain values. When a monolithic system or system with reduced number of components is used, the relative motion between components may be reduced. Reducing relative motion between the components of the system 10 may simplify calculations and reduce error in the output since the deformation that induces strain may be better transferred to the strain gauges.

In some embodiments, the mechanical coupling of the transducer 300 to the transducer structure 100 may be lossless. Accordingly, hysteresis, friction, and/or elastic deformation may be reduced, thereby reducing error in the measured deformation values. The dynamic measuring unit 400 may be losslessly coupled to the transducer structure 100 or another component of the system 10. The connection may be rigid, to reduce variation in hysteresis, friction, and/or elastic deformation. The connection may use springs and/or dampers, provided they have known constants that may allow for compensation in the measured values.

In some embodiments, the transducer 300 may be registered to the transducer structure 100 so that the one or more strain gauges 310 in the transducer 300 may be in a known position relative to the transducer structure 100. This pre-registration may improve the calculated output of the system 10 by reducing errors and simplifying calculations using the measurements from the transducer 300.

An advantage of using known spatial values is that the dynamic measuring unit 400 may not need to be positioned at the center of mass of the transducer structure 100. In other words, the dynamic measuring unit 400 may be positioned anywhere in the system 10, provided that its location is known and may be factored into the calculated output values. For example, the dynamic measuring unit 400 may be positioned on the transducer structure 100 and may be offset from the position of the object 40 coupled to the coupling member 22. In some embodiments, the dynamic measuring unit 400 may be coupled to another component of the system 10, adjacent the object 40 and at a distance from the transducer structure 100. For example, if there is a rigid member between the coupling member 22 and the transducer structure 100, the dynamic measuring unit 400 may be positioned adjacent the coupling member 22. Accordingly, the dynamic measuring unit 400 may be approximately or exactly moved with the object 40 such that the known motion of the coupling member 22 measured by the dynamic measuring unit 400 may be used to compensate and modify the input values of the system 10.

The use of spatially known relationships may allow for the system 10 to operate at higher speeds. Due to the reduction in computational complexity resulting from fewer degrees of freedom, the system 10 may operate with higher frequencies and shorter length components, such as the distance between the coupling member 22 and the transducer structure 100. While operating at higher frequencies with shorter length components may result in the generation of standing waves, the simplified computational complexity may enable these standing waves to be more easily accounted and compensated for.

The controller 500 may be in a wired connection with the transducer 300 and/or dynamic measuring unit 400 or may receive data wirelessly. In some embodiments, the controller 500 may be separate from the rest of the system 10 and may perform or facilitate the performance of calculations based on the measured data. In other words, the controller 500 may be part of an external computational system that is in data communication with the system 10. For example, the known relationship between the various components of the system 10 may allow the strain gauges 310 to operate as position sensors, thereby simplifying calculations for acceleration and deformation.

The controller 500 may be operable to control the movement of the object 40 coupled to the coupling member 22 in a cartesian plane, as described previously, and/or in an angular plane.

In some embodiments, there may be a communication module in communication with the controller 500 and one or more external control systems. For example, the communications module may receive processed data that has been converted into, e.g., ethernet data for streaming by an ethernet system.

### System Configuration

The system 10 may be configured to simplify and otherwise improve the accuracy and/or efficiency of determining one or more parameters of an object 40 to be coupled to the coupling member 22. As described above, one or more of the mass, moment of inertia, and/or centre of gravity of the object 40 may be determined by using the controller 500 and received deformation, acceleration, and/or angular value measurements.

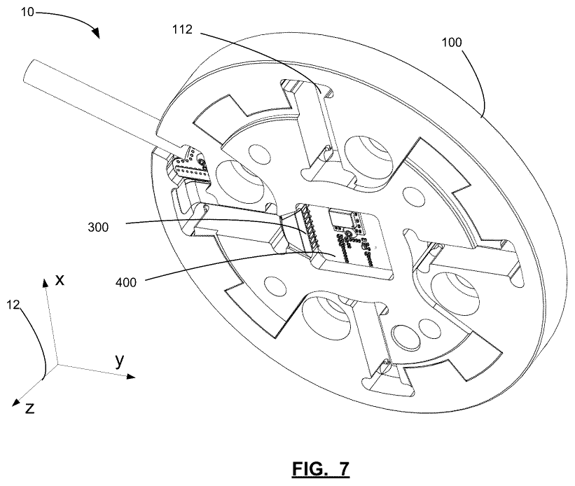

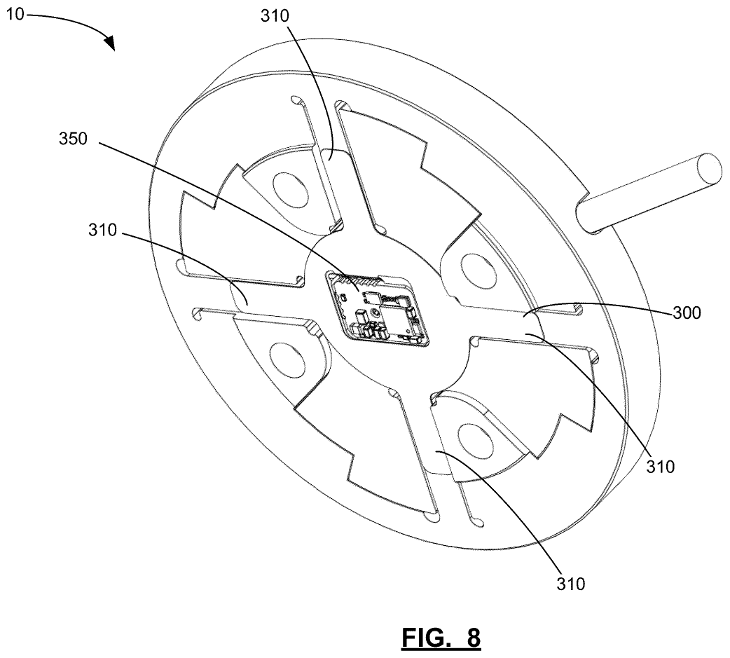

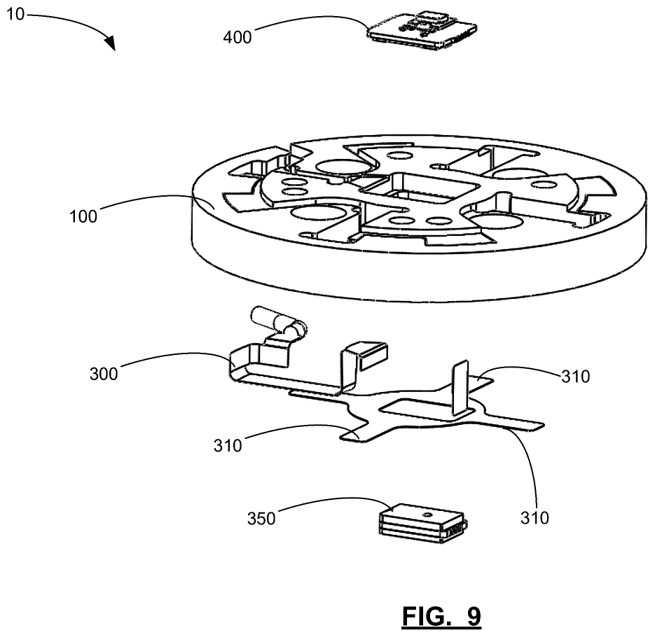

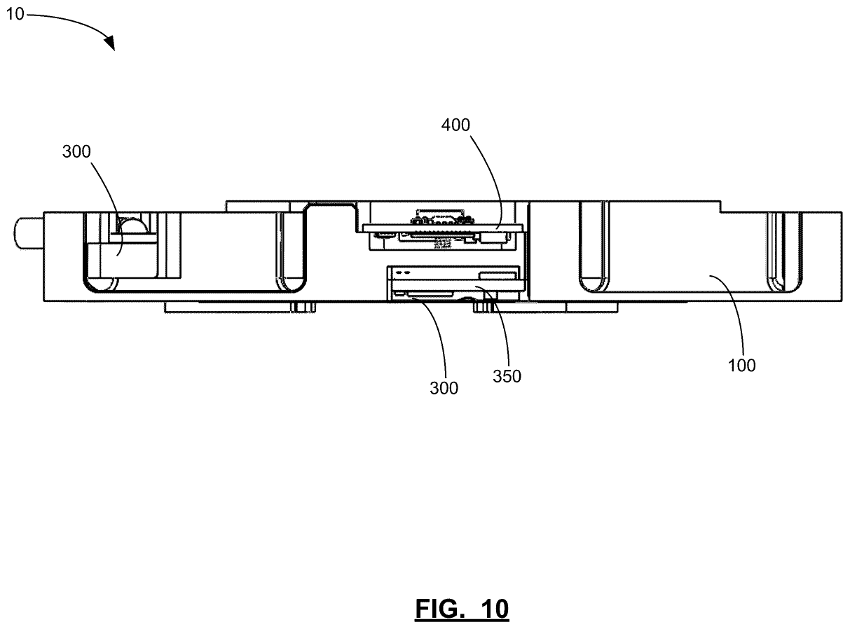

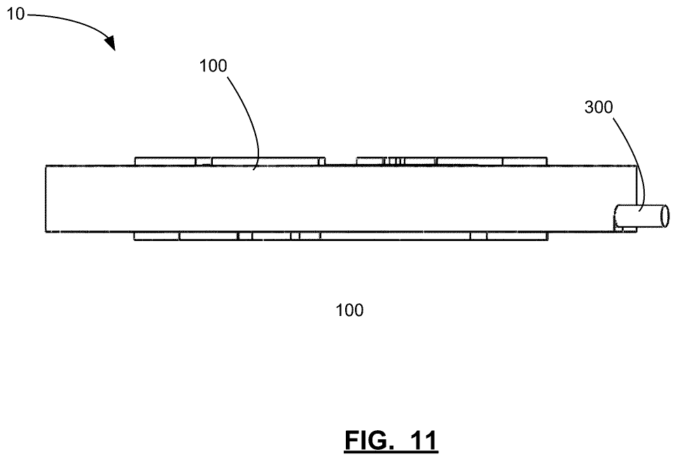

Referring to FIGS. 5-11, shown therein is an example three degree of freedom (DOF) system 10. The three DOF system has three surfaces to be measured 110, with each surface to be measured 110 having a respective strain sensor in the transducer 300. As shown, each surface to be measured 110 may be an elongate beam 112. As shown in FIG. 7, the coordinate system 12 has three directions x, y, and z. In other words, there is a first direction, a second direction, and a third direction, with each direction being perpendicular from the others.

The use of a three DOF system may allow for a simplification of calculations when determining the mass, moment of inertia, and/or centre of gravity. For example, the measured Fz force may be affected by one or more other forces acting on the object 40 due to its dynamic motion. By measuring the My and Mx across a full circular range (360 degrees) these undesired effects may be cancelled out leaving the resultant Fz force as the calculated value. The resultant Fz force may then be used to facilitate the determination of the mass, moment of inertia, and/or centre of gravity. Additionally, there may be situations where the measured Fz is relatively insignificant in comparison to Mx and My due to the orientation of the object 40, thereby rendering the measurement inaccurate for the determination of the mass. In these situations, the Mx and My measurements may be used along with the relatively insignificant Fz measurement to cancel out the effect of the centre of gravity, which may enable the calculation of the desired parameters directly from the resultant moments. In other words, the use of three surfaces to be measured may enable the calculation of the desired parameters across the entire range of motion of the object in 3D space, thereby simplifying the calculations and reducing error.

Referring to FIG. 6, the transducer structure 100 has four surfaces 110a-110d. The first surface 110a and third surface 110c are in the first direction and the second surface 110b and the fourth surface 110d are in the second direction. In other words, the strain gauges 310 are positioned in a plane formed by the first and second directions. In some embodiments, there may only be three surfaces 110 for a 3 DoF configuration. The fourth surface 110 may be used to reduce cross-talk by introducing an additional variable.

This configuration may be applicable in scenarios where the object 40 is moved by the coupling member 22 in a direction generally parallel to gravity at a relatively constant velocity. In other words, the Fz component of the applied force may be calculated in the direction of gravity, simplifying the calculations of mass, moment of inertia, and/or centre of gravity. However, if the object 40 is moved in a non-linear motion, e.g., an arc, the Fz component of the applied force may no longer be aligned with the direction of gravity. Additionally, the motion of the object 40 may have varying accelerations, requiring more complex calculations to determine the desired parameters. Accordingly, the dynamic measuring unit 400 may be used to compensate for the increased complexity in the motion of the object 40, including the variation in motion caused by rotation and/or acceleration of the object 40.

The dynamic measuring unit 400 may be used to measure one or more accelerations and/or an angular value of the object 40. For example, when the dynamic measuring unit 400 is an accelerometer, it may determine the linear acceleration of the object 40 as it is moved by the coupling member 22, and when the dynamic measuring unit is a gyroscope, it may determine the angular value of the object 40 in 3D space. In some embodiments, as exemplified in FIG. 5, the dynamic measuring unit 400 may be an IMU that is capable of determining both acceleration and the angular value of the object 40.

The controller 500 may be configured to determine the force acting on the object 40 in the third direction (e.g., Fz) based on the deformation measurements of the transducer 300 and the acceleration and/or angular value measurements from the dynamic measuring unit 400. The acceleration value may allow for the mass, moment of inertia, and/or centre of gravity to be determined when the object 40 is moving at a non-constant velocity. When the object 40 moves in a non-linear motion, the dynamic measuring unit 400 and controller 500 may be used to determine an angular offset between the angular value of the object 40 and a direction of gravity, and subsequently may allow for the determination of the mass, moment of inertia, and/or center of gravity based on the determined Fz force and angular offset.

When the object 40 is moved with non-linear motion with a non-constant velocity, the mass, moment of inertia, and/or centre of gravity may be determined based on the calculated Fz force, the angular offset, and the acceleration measurements. In other words, the Fz value determined from the transducer 300 may vary relative to the direction of gravity as the angular position of the object 40 is changed. The use of the dynamic measuring unit 400 to measure the angular value may allow for an accurate calculation of Fz even when being moved at an angle relative to gravity.

Thus, the three DOF configuration may allow for a simplified calculation of the mass, moment of inertia, and/or centre of gravity by cancelling out deformation parameters. The use of a mechanical system to cancel out parameters and simplify calculations may reduce error and computational power required to calculate the desired parameter. Additionally, the use of the three DOF system may reduce or eliminate the need for features designed to reduce crosstalk, such as compliant beams. In contrast, a more complicated six DOF system may need compliant beams to reduce crosstalk and may introduce exponentially increased complexity in calculating the desired parameters.

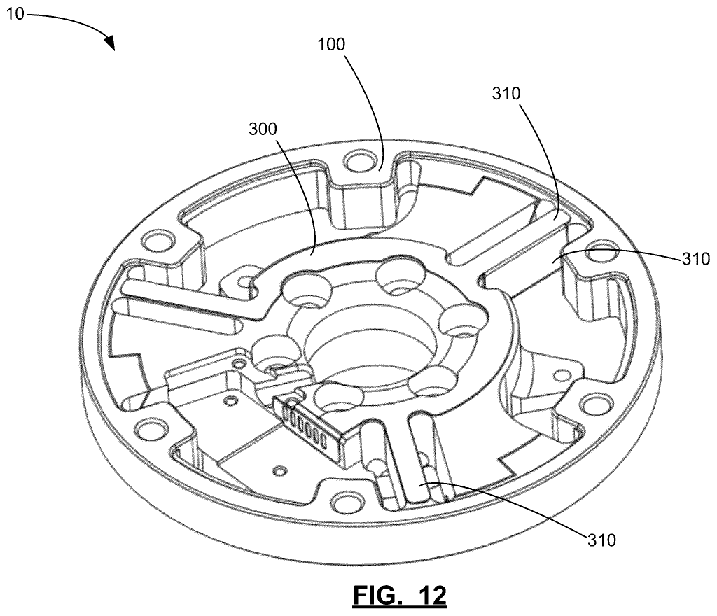

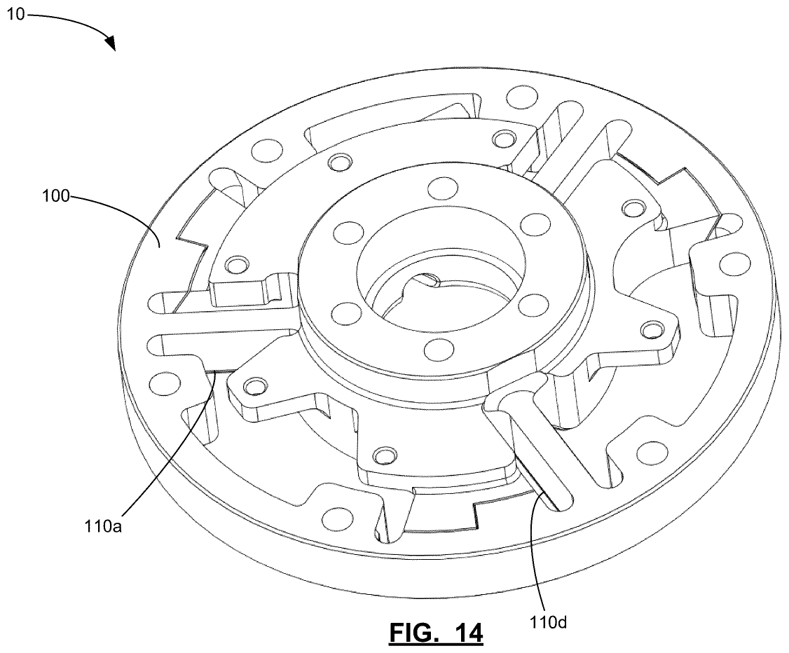

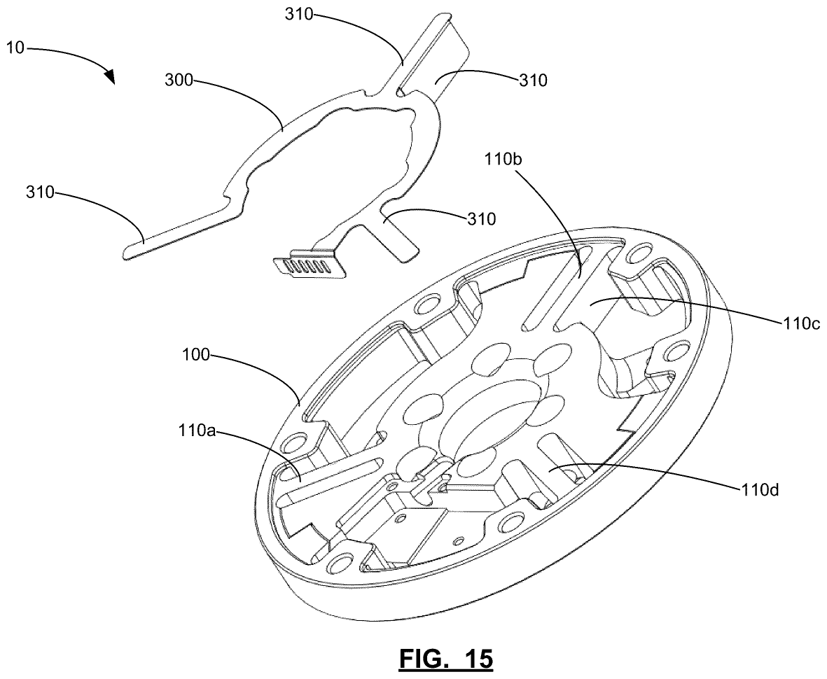

In some embodiments, the plurality of strain sensors may include at least two strain sensors with at least one strain sensor configured to measure the deformation of the transducer system 10 as a result of torque and at least one strain sensor configured to measure deformation of the transducer system 10 as a result of force. The controller 500 may be configured to use the measured force and torque to determine the at least one of mass, moment of inertia, and/or centre of gravity of the object 40 coupled to the coupling member 22. For example, referring to FIGS. 12-15, as shown, the transducer structure 100 has a transducer 300 with four strain sensors and four surfaces to be measured 110.

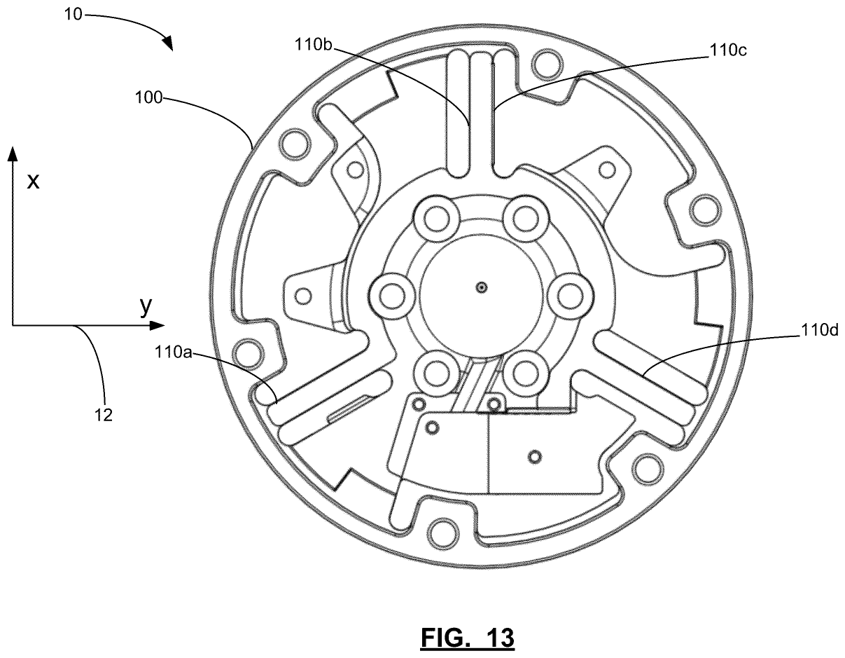

Referring to FIG. 13, the transducer structure 100 has a first surface 110a in the first direction with a second surface 110b and a third surface 110c in a direction that is a combination of each of the first and the second directions. In other words, the strain gauges 310 are positioned in a plane formed by the first and second directions. This configuration may allow for the applied force to create a positive strain value across two of the surfaces to be measured and a negative strain value in the third surface to be measured, or vice versa. In other words, one surface to be measured 110 may be in tension and two surfaces to be measured 110 may be in compression. Accordingly, the Fx and Fy components may be cancelled across the x-y plane, allowing for the Fz component to be more easily determined.

As exemplified in FIG. 13, three of the strain sensors are positioned in the x-y plane and as exemplified in FIG. 12, the fourth strain sensor is on the surface to be measured 110d that is in the z-direction. Accordingly, the fourth strain sensor may be used to measure deformation of the transducer system 10 as a result of torque.

An advantage of this configuration is that torque may be measured and used to improve the accuracy of the calculation of the mass, moment of inertia, and/or centre of gravity. For example, if the object 40 is picked up by the coupling member 22 and is rotated at least partially about the z-axis, torque may be introduced into the transducer system 10. This rotational torque, if left uncompensated for, may introduce enough error in the movement of the object 40 to damage or dislodge the object 40 coupled to the coupling member 22. The calculation and use of torque in the output values may reduce the likelihood of dropping or otherwise damaging the object 40 and/or the system 10 by properly compensating for the movement of the object 40.

### Feedback

The system 10 may be operable to control the motion of an object 40 coupled to the coupling member 22 based on the determined mass, moment of inertia, and/or center of gravity. In other words, once the controller 500 has facilitated the determination of one of the desired output parameters, one or more output parameters may be used in a feedback loop to modify the control of the motion of the object 40. For example, the controller 500 may be configured to control the movement of the object 40 using the actuator 24 based on the determined mass, moment of inertia, and/or the centre of gravity. In some embodiments, the controller 500 may package the determined output data for use by one or more additional systems. The packaged data may be in analog and/or digital format. For example, the data may be packaged for, including, but not limited to, USB, CAN, bus, analog, and/or ethernet. The packaged data may be sent to one or more control systems. For example, the data may be sent to a control system that may control the actuator 24 and/or to a control system that controls the coupling strength of the coupling member 22. In embodiments, where the coupling member 22 is a grip, the control system may use the packaged data to control the strength of the grip.

An advantage of using the controller 500 to optimize the motion of the object 40 based on calculated output parameters is that the system 10 may operate with more complex motion. For example, if the object 40 is moved in a non-linear (e.g., parabolic or arcuate) motion, the object 40 will experience varying velocities and accelerations. By using a feedback mechanism based on the mass, moment of inertia, and/or centre of gravity of the object 40, the object 40 may be moved in such a way that the likelihood of dislodging from the coupling member 22 may be reduced. Additionally, likelihood of damage to the object 40 and/or the system 10 may be reduced.

The feedback mechanism may also allow for the optimized or improved motion of objects 40 that are compliant and/or have a shifting centre of gravity. For example, if the object 40 is a bag, the bag has a particular structural compliance based on how it deforms or may deform due to the coupling of the bag to the coupling member 22 and undergoing a change in acceleration. As another example, the object 40 may include a liquid, resulting in a change in centre of gravity with acceleration. For example, if the object 40 is picked up, it may have a first centre of gravity and after the object 40 is moved, the acceleration may cause a shift in the centre of gravity to a second centre of gravity. This acceleration shift may cause an increase in applied force acting on the object 40 and the coupling member 22, potentially causing the object 40 to be dislodged and/or damaged. The acceleration shift may be a temporary or permanent shift, depending on the object 40.

In some embodiments, the object 40 may be a single type of food item or a variety of types of food items. The system 10 may be used to detect the structural compliance of each type of food as it is being coupled to the coupling member 22. Detecting the structural compliance may be important depending on the type of food being picked up. For example, picking up imitation grab will require a different sensitivity of handling with the coupling member 22 than picking up, e.g., an apple.

Each object 40 may be associated with a threshold velocity and/or a threshold acceleration. The threshold velocity is the velocity that, if exceeded, may cause damage to the object 40 or the system 10 or may cause the object 40 to be decoupled from the coupling member 22. The threshold acceleration is the acceleration that, if exceeded, may cause damage to the object 40 or the system 10 or may cause the object 40 to be decoupled from the coupling member 22. The threshold velocity and/or threshold acceleration may be determined based on a structural compliance value of the object 40, the coupling force between the object 40 and the coupling member 22, and/or an acceleration shift parameter of the object 40. These parameters may be referred to as prediction parameters, for predicting the motion of the object 40 based on a desired velocity and/or acceleration.

The prediction parameters may be used to modify the motion of the object 40 over time. For example, the controller 500 may be configured to update the threshold velocity and/or the threshold acceleration over time and control the movement of the object 40 with the actuator 24 based on the updated threshold velocity and/or acceleration. Controlling the movement of the object 40 may involve moving the object 40 below the threshold velocity and/or the threshold acceleration. Moving below the threshold values may reduce the likelihood of damage to the object 40, the system 10, and/or causing the object 40 to be dislodged from the coupling member 22.

One or more prediction parameters may be stored in a memory of the system 10, accessible by the controller 500. The prediction parameters may be pre-stored or programmed into the memory prior to use of the system 10. For example, the objects 40 being moved by the system 10 may be relatively consistent, such that the prediction parameters are known prior to use of the system 10. The prediction parameters may be stored in memory in the system 10 such that the controller 500 or other computational device can access the memory to modify the movement of the object 40 based on the known prediction parameters.

The prediction parameters may be calculated based on use of the system 10 and stored in memory. For example, the prediction parameters may be calculated upon an initial movement of the object 40 and may be stored in memory to be accessed by the controller 500. The stored values for the prediction parameters may be updated over time to compensate for changing acceleration and centre of gravity. For example, the system 10 may operate a calibration sequence with no object 40 coupled to the coupling member 22 to understand the movement and deformation of the system 10 pre-loading. Once an object 40 is coupled to the coupling member 22, the system 10 may move through an initial sequence to determine one or more prediction parameters. As described above, the prediction parameter(s) may then be accessed by the controller 500 to update the motion of the object 40. As the system 10 moves the object 40 through one or more secondary sequences, the prediction parameter(s) may be updated over time. Updating the prediction parameter(s) over time may allow for a more consistent compensation of movement of the object 40 based on the variation in acceleration and/or angular values.

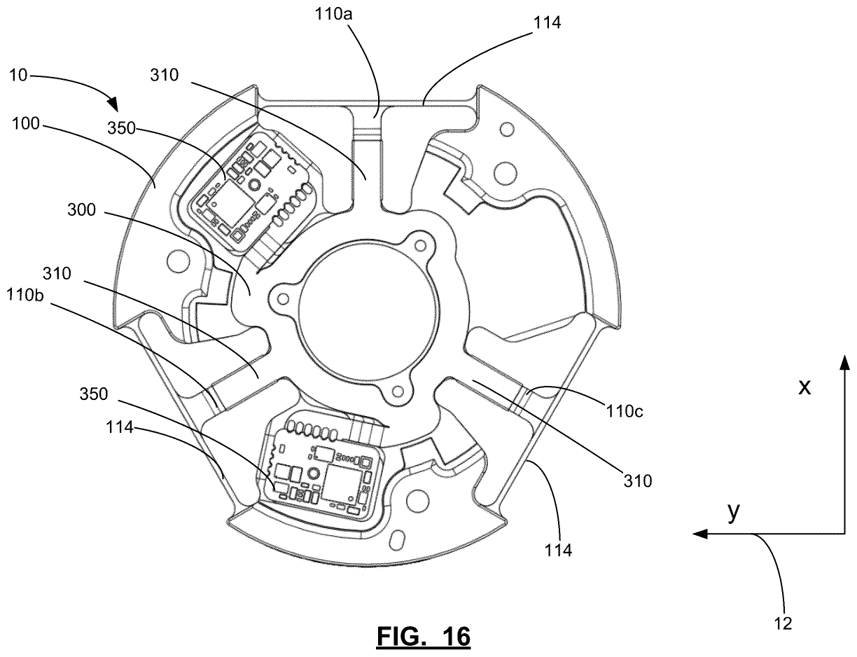

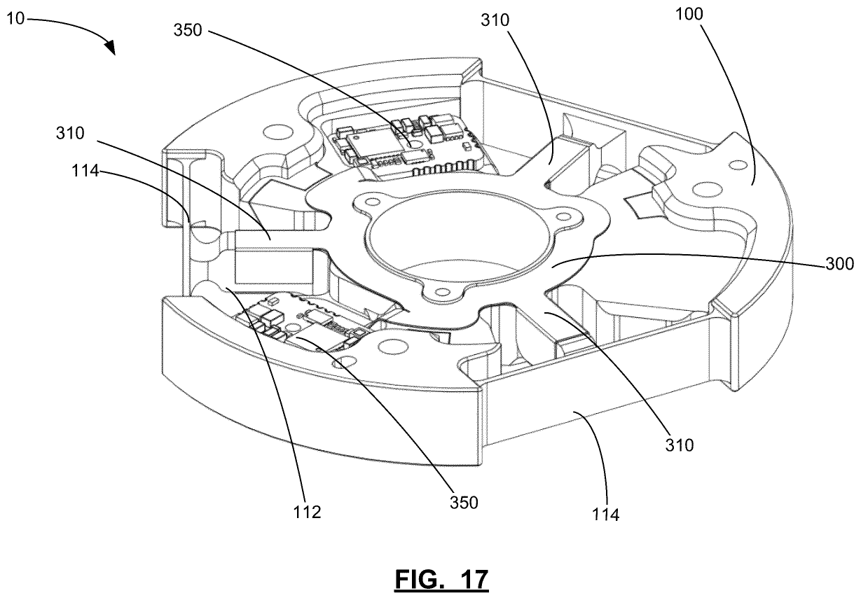

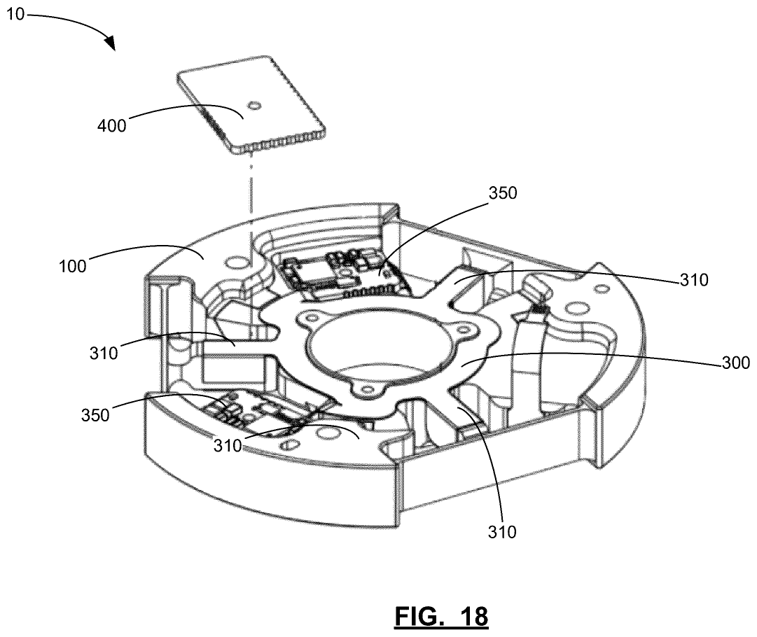

In some embodiments, the plurality of strain sensors may include six sensors (i.e., exactly six or more than six). The exemplary embodiment of FIGS. 16-18 includes six sensors (e.g., six strain sensors 310). Embodiments including six sensor may be designed in a six DOF configuration. The exemplary embodiment of FIGS. 16-18 is an exemplary six DOF system. In some examples, a six DOF system includes twelve surfaces to be measured 110, with each surface having a respective strain sensor in the transducer 300. In some examples a six DOF system has less than twelve surfaces to be measures each with a respective strain sensor. In some examples, a six DOF system has as few as three surfaces with each surface having a respective linear and/or shear strain sensor in transducer 300. In some examples, each surface to be measured 110 is a surface of an elongate beam 112 affixed to a compliant beam 114. As shown in FIG. 16, the coordinate system 12 has three directions x, y, and z. In other words, there is a first direction, a second direction, and a third direction, with each direction being perpendicular from the others.

Referring to FIG. 16, the exemplary transducer structure 100 has three surfaces 110a-110c each on a respective one of three structures (e.g., three discrete beams). One structure of the three structures of the exemplary transducer structure 100 of FIG. 16 is in line with the global planar axis but the other two are not. Additional computation is required to transform the coordinates of the latter two structures of the exemplary transducer structure 100 of FIG. 16 to have them aligned to the global cartesian coordinate like the first structure. Each structure of the exemplary transducer structure 100 of FIG. 16 has a rectangular cross section and four strain sensing elements placed on this structure, one on each exposed face for a total of twelve strain sensing elements. Alternatively, one or more of the structures on which surfaces to be measures 110 are formed may include less than four strain sensing elements, such as a total of six strain sensing elements (e.g., three structures each with two strain sensing elements).

This configuration may be applicable in, e.g., scenarios where the object 40 is moved by a coupling member 22 in a substantially constant direction and linear and angular velocity relative to gravity. In other words, the overall force and moment vectors can be calculated fully accounting effects of gravity, simplifying the calculations of mass, moment of inertia, and/or centre of gravity. However, if the object 40 is moved in a non-linear and/or accelerating motion, e.g., an arc, the force component of the applied force may no longer be aligned with the direction of gravity and it may not be possible to calculate the mass, moment of inertia and/or centre of gravity. The dynamic measuring unit 400 may be used to compensate for the changes in one or more of the direction, linear velocity, and angular velocity allowing the measurement of one or more of mass, moment of inertia, and/or centre of gravity.

The controller 500 may be configured with the dynamic measuring unit 400 to determine the mass, moment of inertia, and/or centre of gravity of the object 40 in any motion or orientation in space. In addition, the dynamic acceleration and angular position information from unit 400 and controller 500 may further aid in determining the component forces and moments that may be difficult to interpret due to inherent crosstalk.

When the object 40 is moved with non-linear motion with a non-constant velocity, the mass, moment of inertia, and/or centre of gravity may be determined based on the calculated force component closest to gravity, the angular offset, and the acceleration measurements. In other words, the force value determined from the transducer 300 may vary relative to the direction of gravity as the angular position of the object 40 is changed. The use of the dynamic measuring unit 400 to measure the angular value may allow for an accurate calculation of component forces even when being moved at an angle relative to gravity.

The use of a six DOF system resolves moment and forces on all three orthogonal axes which allows for a complete resolution in all directions. The advantage of this is that the centre of mass of the object 40 is of no concern as its mass can be derived from the increased number of force and moment vectors regardless of orientation. In addition, when the orientation of the sensing system 10 renders the DOF of interest insignificant, the remaining DOFs can help resolve the DOF of interest. The system 10 incorporates the usage of compliant beams which complicate the force and moment parameter computation and increases the system crosstalk.

Thus, the six DOF configuration may allow for mass, moment of inertia, and/or centre of gravity readings at all orientations in 3D space. The use of compliant beams allows for more sensitive readings of forces and moments in all axes. Additionally, the use of the measuring unit 400 and controller 500 with transducer 300 may provide a more accurate mass, moment of inertia, and/or centre of gravity by providing acceleration and/or angular value measurements data both in dynamic and static cases.

### Method of Processing Data

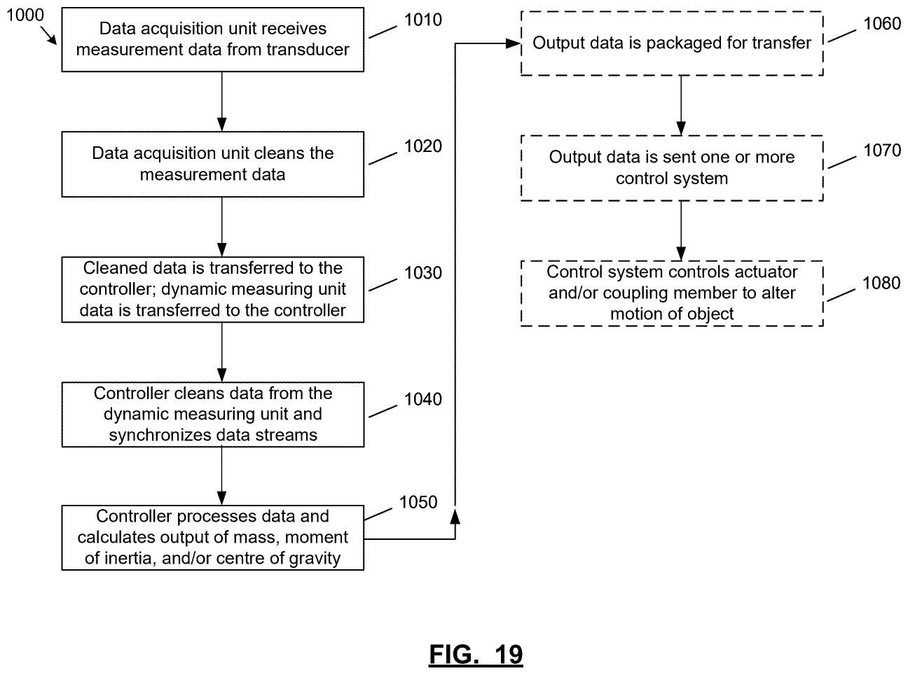

Referring to FIG. 19, shown therein is a flow chart illustrating an example method 1000 of processing data in the system 10. As shown, the method 1000 references the data acquisition unit 350, transducer 300, controller 500, and the dynamic measuring unit 400. It will be appreciated that these components and steps are examples, and may not be present in each instance of data flow. Additionally, the method 1000 may include one or more additional components and/or steps.

At 1010, the data acquisition unit 350 may receive measurement data from the transducer 300.

At 1020, the data acquisition unit 350 may clean the data. For example, the signal may be conditioned by one or more of calibration, taring, or normalizing the data.

At 1030, the cleaned measurement data may be sent to the controller 500. Data from the dynamic measuring unit 400 may be sent to the controller 500. Optionally, any other system data from additional sensors may be transferred to the controller 500.

At 1040, the controller 500 may condition the new data, thereby cleaning it. The controller 500 may synchronize the cleaned data from one or more sources.

At 1050, the controller 500 may process the synchronized data and calculate the output of at least one or mass, moment of inertia, and/or centre of gravity.

At 1060, the output data may be optionally packaged for transfer to another component of the system. For example, the data may be packaged for USB, CAN bus, and/or ethernet. One or more other forms of packaging may be used.

At 1070, the data may be optionally sent to one or more control systems. For example, the control system may be for the actuator and/or for the coupling member.

At 1080, the control system may modify the control of the actuator to alter the motion of the object.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A transducer system, the transducer system comprising:
a transducer structure having a plurality of surfaces to be measured and at least one coupling member for removably coupling an object to the transducer structure;
a transducer coupled to the transducer structure, the transducer having at least one strain sensor coupled to the plurality of surfaces to be measured for measuring deformation of the transducer structure in a plurality of directions;
a dynamic measurement unit for measuring at least one acceleration of the object; and
at least one controller configured to:
receive the deformation measurements in the plurality of directions;
receive the acceleration measurements; and
when the object is removably coupled to the coupling member, determine at least one of mass, moment of inertia, and centre of gravity of the object based on the deformation and acceleration measurements.

2. The transducer system of claim 1, wherein the dynamic measuring unit is at least one of a gyroscope, an accelerometer, and an inertial measurement unit.

3. The transducer system of claim 1, wherein the at least one strain sensor is a plurality of strain sensors.

4. The transducer system of claim 3, wherein the plurality of strain sensors includes at least three strain sensors and the plurality of directions includes a first direction, a second direction, and a third direction, wherein each of the first direction, the second direction, and the third direction are perpendicular from one another,
wherein the at least one controller is further configured to:
when the object is coupled to the coupling member, determine a force acting in the third direction based on deformation measurements from the three strain sensors in the first direction and the second directions and measure at least one angular value of the object using the dynamic measuring unit;
determine an angular offset between the angular value of the object and a direction of gravity; and
determine the at least one of mass, moment of inertia, and centre of gravity of the object based on the force and angular offset.

5. The transducer system of claim 4, wherein the plurality of strain sensors includes at least four strain sensors,
wherein when the object is coupled to the coupling member, at least one strain sensor of the plurality of strain sensors is configured to measure deformation of the transducer system as a result of torque, and
wherein the controller is further configured to:
determine the at least one of mass, moment of inertia, and centre of gravity of the object based on the force, torque, and angular offset.

6. The transducer system of claim 3, wherein the plurality of strain sensors includes at least two strain sensors,
wherein when the object is coupled to the coupling member, at least one strain sensor of the plurality of strain sensors is configured to measure deformation of the transducer system as a result of torque and at least one strain sensor of the plurality of strain sensors is configured to measure deformation of the transducer system as a result of force, and
wherein the controller is further configured to:
determine the at least one of mass, moment of inertia, and centre of gravity of the object based on the force and torque.

7. The transducer system of claim 3, wherein the plurality of strain sensors includes at least six strain sensors and the plurality of directions includes a first direction, a second direction, and a third direction, wherein each of the first direction, the second direction, and the third direction are perpendicular from one another,
wherein the at least one controller is further configured to:
when the object is coupled to the coupling member, determine a force and/or moment acting in the first, second, and third directions based on deformation measurements from the six strain sensors in the first direction, the second direction, the third direction, and measure at least one angular value of the object using the dynamic measuring unit;
determine an angular offset between the angular value of the object and a direction of gravity; and
determine the at least one of mass, moment of inertia, and centre of gravity of the object based on the force and angular offset.

8. The transducer system of claim 1, wherein the transducer structure, the dynamic measuring unit, and the coupling member are mechanically linked.

9. The transducer system of claim 1, wherein the at least one controller is further configured to time synchronize the deformation measurements and the acceleration measurements.

10. The transducer system of claim 1, further comprising at least one actuator for actuating the at least one coupling member to control a movement of the object when the object is coupled to the coupling member.

11. The transducer system of claim 10, wherein the controller is operable to control the movement of the object in at least one of an angular plane and a cartesian plane using the actuator.

12. The transducer system of claim 10, wherein movement of the object includes at least one of linear velocity, linear acceleration, angular velocity, and angular acceleration.

13. The transducer system of claim 10, wherein the at least one controller is further configured to control the movement of the object with the at least one actuator based on at least one of the determined mass, moment of inertia, and centre of gravity.

14. The transducer system of claim 10, wherein the at least one controller is further configured to:
determine at least one of a structural compliance of the object and a coupling force between the object and the at least one coupling member;
determine a threshold velocity and a threshold acceleration based on at least one of the structural compliance and the coupling force; and
actuate the object with the actuator to move the object below the threshold velocity and the threshold acceleration.

15. The transducer system of claim 14, wherein the at least one controller is further configured to update the threshold velocity and the threshold acceleration over time and to control the movement of the object with the actuator based on the updated threshold velocity and the threshold acceleration.

16. The transducer system of claim 14, wherein the at least one controller is further configured to:
access a memory, the memory containing an acceleration shift parameter, predict a change in the center of gravity of the object based on the acceleration shift parameter; and
modify the movement of the object using the at least one actuator based on the acceleration shift parameter such that the object moves below the threshold velocity and the threshold acceleration.

17. The transducer system of claim 16, wherein the acceleration shift parameter is determined by operating the at least one actuator to move the object through an initial sequence.

18. The transducer system of claim 17, wherein the at least one actuator is operated to move the object through one or more secondary sequences and the acceleration shift parameter is updated over time.

19. The transducer system of claim 16, wherein the acceleration shift parameter is programmed into the memory prior to operation of the transducer system.
